(19) United States
(12) Patent Application Publication
(10) Pub. No.: US 2009/0205517 A1
(43) Pub. Date: Aug. 20, 2009

(54) STENCIL PRINTING APPARATUS

(75) Inventor: Takamitsu Miyawaki, Wakayama (JP)

Correspondence Address: BUCHANAN, INGERSOLL & ROONEY PC, POST OFFICE BOX 1404, ALEXANDRIA, VA, 22313-1404, US

(73) Assignee: Duplo Seiko Corporation, Kinokawa-shi, WAKAYAMA (JP)

(21) Appl. No.: 12/439,029

(22) PCT Filed: Apr. 12, 2007
(86) PCT No.: PCT/JP2007/058045

§ 371 Date: Feb. 26, 2009

(30) Foreign Application Priority Data
Sep. 20, 2006 (JP) 2006-254754

(51) Int. Cl. B41L 13/00

(52) U.S. Cl. 101/118

(57) ABSTRACT

The present invention provides an adjusting mechanism in which a paper feed timing adjustment member (95) is moved around the axis of a rotary shaft of a cam by an adjustment member drive means so as to adjust the position of an end of a second arm and then the position of a cam follower on a sliding surface of the cam, thereby adjusting a timing at which a paper feed drive means drives a timing roller, wherein there is provided an urging means (98) for constantly urging the paper feed timing adjustment member (95) in either one of directions around the axis of the rotary shaft of the cam.

### TECHNICAL FIELD

The present invention relates to stencil printing apparatuses, and in particular relates to mechanisms for adjusting paper feed timings of timing rollers.

### BACKGROUND ART

Well-known examples of mechanisms for adjusting paper feed timings of timing rollers include mechanisms disclosed in Patent Documents 1 and 2 and shown in FIG. 12. In the mechanism disclosed in Patent Document 1, a paper feed timing is adjusted by using a planet gear. In the mechanism disclosed in Patent Document 2, a pulley and a cam are used, a drive member for a timing roller is operated by the cam, and the operation position of the cam is adjusted, thereby adjusting a paper feed timing.

In the mechanism shown in FIG. 12, a paper feed timing adjustment member 95 is moved around the axis of a rotary shaft 911 of a cam 91 by an adjustment member drive means 96 so as to adjust the position of an end 9321 of a second arm 932 and then the position of a cam follower 92 on a sliding surface 912 of the cam 91, thereby adjusting a timing at which a paper feed drive means 94 drives a timing roller 41.

Patent Document 1: Japanese Examined Patent Application Publication No. 5-83460

Patent Document 2: Japanese Unexamined Patent Application Publication No. 9-66657

### DISCLOSURE OF THE INVENTION

### Problems to be Solved by the Invention

In the mechanism shown in FIG. 12, the adjustment member drive means 96 meshes, via a gear 961, with a gear 951 formed on a peripheral surface of the paper feed timing adjustment member 95 as shown in FIG. 13, and rotates so as to cause the paper feed timing adjustment member 95 to be moved around the axis of the rotary shaft 911 of the cam 91 via the meshing of the gears. In other words, the paper feed timing adjustment member 95 and the adjustment member drive means 96 are interlocked due to the continuous meshing of the gear 951 and the gear 961. Further, in general, in the meshing of the gears, a slight gap C is provided between the meshed gears in order to allow a continuous meshing operation to be smoothly carried out, and this is so-called “backlash”.

Therefore, in a state where the adjustment member drive means 96 is rotated in one direction and the gear 951 and the gear 961 are abutted against each other, i.e., in a state shown in FIG. 13, when the paper feed timing adjustment member 95 is moved in one direction (in the direction of an arrow B in this case), and thereafter, the paper feed timing adjustment member 95 is moved in the other direction (in the direction of an arrow A in this case), the following problem occurs. In this case, upon rotation of the adjustment member drive means 96 in the other direction, the gear 961 abuts against the gear 951 after having moved by the gap C. In other words, the lost motion of the adjustment member drive means 96 by the gap C occurs. Therefore, the rotation distance of the paper feed timing adjustment member 95 will be smaller than that of the adjustment member drive means 96 by the gap C.

An object of the present invention is to provide a stencil printing apparatus including a paper feed section capable of, with a simple structure, eliminating a movement difference in adjusting a paper feed timing, which is caused by “backlash”.

### Solution to the Problems

The present invention provides a stencil printing apparatus including: a printing section having a stencil printing plate attachment body around which a stencil paper made into a plate is attached; and a paper feed section for sending a paper to the printing section,

the paper feed section including:

a timing roller for sending the paper to the printing section;

a cam rotated in synchronization with a rotation of the stencil printing plate attachment body;

a cam follower rolled on a sliding surface of the cam;

a link mechanism formed by connecting a first arm and a second arm to each other by using the cam follower as a joint;

paper feed drive means to which an end of the first arm is rotatably connected, and which rotationally drives the timing roller via a pinion gear in accordance with an operation of the first arm;

a paper feed timing adjustment member to which an end of the second arm is rotatably connected, and which adjusts the position of the end of the second arm around the axis of a rotary shaft of the cam; and

adjustment member drive means that meshes, via its gear, with a gear formed on a peripheral surface of the paper feed timing adjustment member, and rotates so as to cause the paper feed timing adjustment member to be moved around the axis of the rotary shaft of the cam via the meshing of the gears,

the paper feed timing adjustment member being moved around the axis of the rotary shaft of the cam by the adjustment member drive means so as to adjust the position of the end of the second arm and then the position of the cam follower on the sliding surface of the cam, thereby adjusting a driving timing of the paper feed drive means,

wherein there is provided urging means for constantly urging the paper feed timing adjustment member in either one of directions around the axis of the rotary shaft of the cam.

### EFFECTS OF THE INVENTION

According to the present invention, the paper feed timing adjustment member is constantly urged in either one of directions around the axis of the rotary shaft of the cam, and therefore, the gear of the paper feed timing adjustment member is constantly abutted against the gear of the adjustment member drive means from the opposite side of the direction in which the paper feed timing adjustment member is urged. Accordingly, even if the adjustment member drive means is moved in either direction, the lost motion of the gear of the adjustment member drive means will not occur. Consequently, it is possible to prevent the occurrence of a movement difference in adjusting a paper feed timing, which is caused by “backlash”; hence, it is possible to accurately adjust the paper feed timing of the timing roller.

### BRIEF DESCRIPTION OF THE DRAWINGS

FIG. 1 is a schematic longitudinal cross-sectional view of a stencil printing apparatus according to one embodiment of the present invention.

FIG. 2 is a transparent perspective view showing principal parts of an adjusting mechanism of the present invention.

FIG. 3 is an enlarged view showing the principal parts used for an operation of the adjusting mechanism of the present invention.

FIG. 4 is a schematic longitudinal cross-sectional view of a stencil printing apparatus according to another embodiment, in which the adjusting mechanism of the present invention can be adopted.

FIG. 5 is a schematic longitudinal cross-sectional view of a stencil printing apparatus according to still another embodiment, in which the adjusting mechanism of the present invention can be adopted.

FIG. 6 is a transparent side view of a master roll holding section, for describing a master roll horizontal holding mechanism that is preferably adopted in the stencil printing apparatus of the present invention.

FIG. 7 is a front view of the holding section shown in FIG. 6, viewed from the front side thereof.

FIG. 8 is a transparent perspective view of the holding section shown in FIG. 6, viewed from below.

FIG. 9 is a perspective view of the stencil printing apparatus with a plate discharge unit opened, for describing a plate discharge unit inclination adjustment mechanism that is preferably adopted in the stencil printing apparatus of the present invention.

FIG. 10 is a transparent side view showing a hinge mechanism for supporting the plate discharge unit shown in FIG. 9.

FIG. 11 is a schematic view of the hinge mechanism shown in FIG. 10.

FIG. 12 is a side view showing an entire conventional adjusting mechanism.

FIG. 13 is an enlarged view showing principal parts used for an operation of the conventional adjusting mechanism.

### DESCRIPTION OF REFERENCE NUMERALS

3 printing section
31 stencil printing plate attachment body
4 paper feed section
41 timing roller
91 cam
911 rotary shaft
912 sliding surface
92 cam follower
93 link mechanism
931 first arm
9311 end
932 second arm
9321 end
94 paper feed drive means
951 gear
971 gear
98 urging means

### BEST MODE FOR CARRYING OUT THE INVENTION

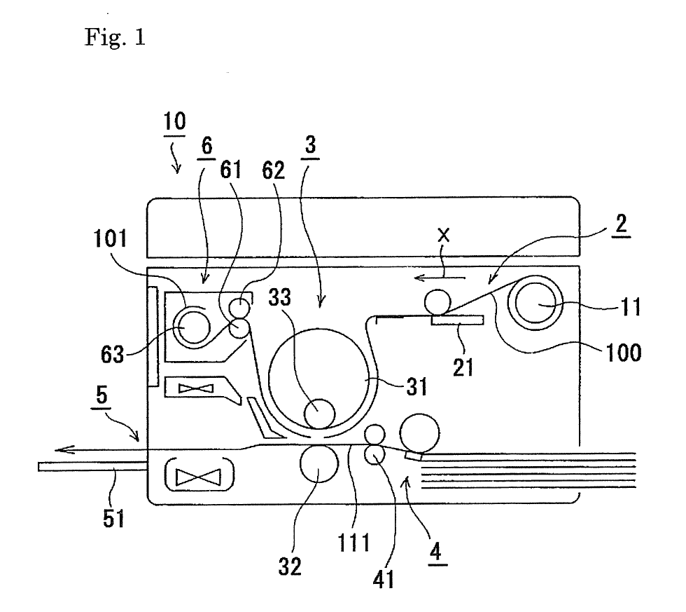

FIG. 1 is a schematic longitudinal cross-sectional view of a stencil printing apparatus according to one embodiment of the present invention. In this stencil printing apparatus 10, a stencil paper (master) 100 is supplied from a master roll 11, and is heated and perforated by a thermal head 21 in a plate-making section 2; thus, the stencil paper 100 is made into a plate, and is supplied to a printing section 3. The supplied stencil paper 100 is sandwiched by a clamping device (not shown), and is wound around a stencil printing plate attachment body 31. On the other hand, a paper 111 is supplied to the printing section 3 by a paper feed section 4. Then, in the printing section 3, the paper 111 is pressed to a roller 33 by a press roller 32 serving as a pressing means, thereby performing printing based on the stencil paper 100. After the printing has been finished, the printed paper 111 is sent to a paper discharge board 51 of a paper discharge section 5, and the stencil paper 101, which has been used for the printing, is peeled off from the stencil printing plate attachment body 31 by drawing rollers 61 and 62 of a plate discharge section 6, and is wound up by a winding core 63.

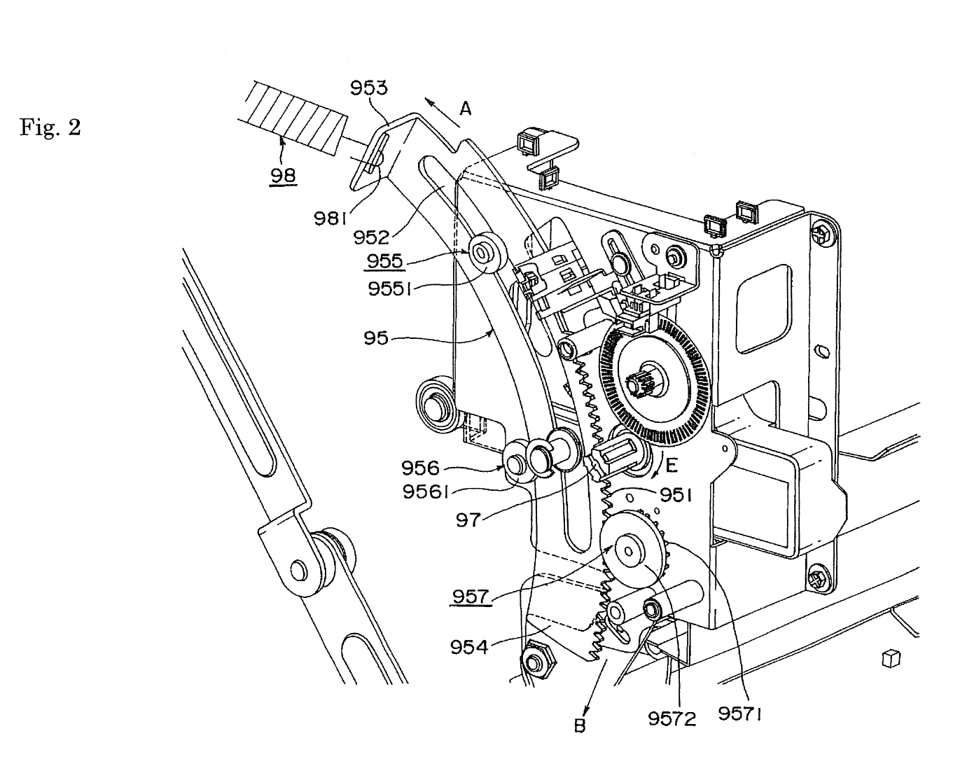

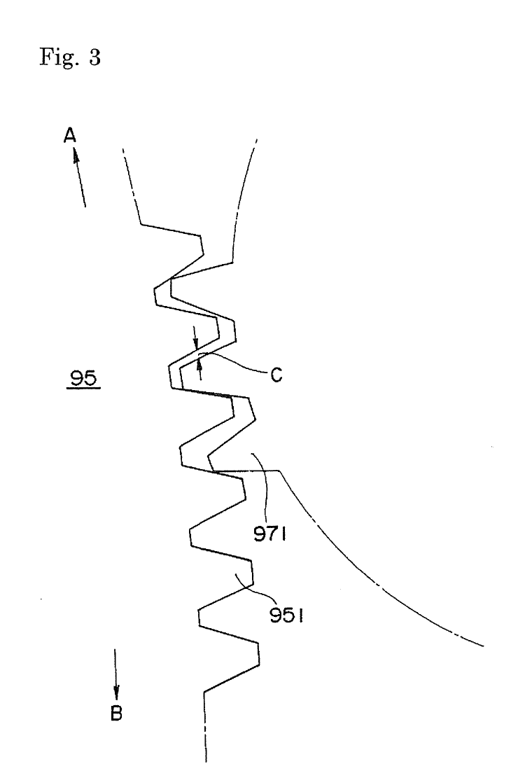

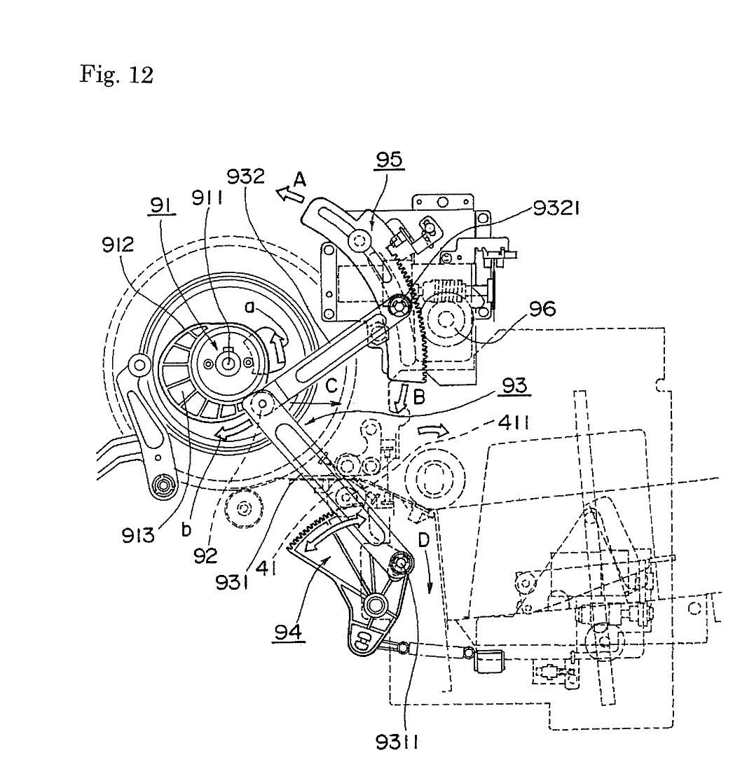

Furthermore, the paper feed section 4 has the following mechanism as an adjusting mechanism for a paper feed timing of a timing roller 41. FIG. 2 is a transparent perspective view showing principal parts of the adjusting mechanism of the present invention. The adjusting mechanism of the present invention has an overall structure similar to that of the conventional mechanism shown in FIG. 12, but differs from the conventional mechanism shown in FIG. 12 with regard to the parts shown in FIG. 2. The following description will be made with reference to FIGS. 2 and 12. Specifically, the paper feed section 4 includes: a cam 91; a cam follower 92; a link mechanism 93; a paper feed drive means 94; a paper feed timing adjustment member 95; and an adjustment member drive means. The cam 91 is provided so as to rotate in synchronization with a rotation of the stencil printing plate attachment body 31. The cam follower 92 is provided so as to roll on a sliding surface 912 of the cam 91. The link mechanism 93 is formed by connecting a first arm 931 and a second arm 932 to each other by using the cam follower 92 as a joint. An end 9311 of the first arm 931 is rotatably connected to the paper feed drive means 94. The paper feed drive means 94 is formed so as to rotationally drive the timing roller 41 via a pinion gear 411 in accordance with an operation of the first arm 931. An end 9321 of the second arm 932 is rotatably connected to the paper feed timing adjustment member 95. The paper feed timing adjustment member 95 is formed so as to adjust the position of the end 9321 of the second arm 932 around the axis of a rotary shaft 911 of the cam 91. The adjustment member drive means is formed by fitting a toothed gear (not shown) into a drive gear shaft 97 shown in FIG. 2. As shown in FIG. 3, this toothed gear has a gear 971, meshes, via the gear 971, with a gear 951 formed on a peripheral surface of the paper feed timing adjustment member 95, and is provided so that a rotation of the toothed gear causes the paper feed timing adjustment member 95 to be moved around the axis of the rotary shaft 911 of the cam 91 via the meshing of the gears.

It should be noted that, in the mechanism shown in FIG. 12, the paper feed timing adjustment member 95 is supported at two positions, but in the present embodiment, the paper feed timing adjustment member 95 is supported at three positions. Specifically, the paper feed timing adjustment member 95 is supported by a first shaft 955, a second shaft 956, and a third shaft 957. The first shaft 955 is slidably located within an elongated hole 952 extending along the direction in which the paper feed timing adjustment member 95 moves, and slightly presses the paper feed timing adjustment member 95 by a flange 9551 at the top. The second shaft 956 is provided at a position located along an inner peripheral edge of the paper feed timing adjustment member 95, and slightly presses the paper feed timing adjustment member 95 by a flange 9561 at the top. The third shaft 957 has a toothed gear 9571 meshing with the gear 951 formed on the peripheral surface of the paper feed timing adjustment member 95, and is provided so that a peripheral edge of a disk 9572 at the top covers the gear 951 of the paper feed timing adjustment member 95.

Furthermore, in the present invention, there is provided an urging means 98 for constantly urging the paper feed timing adjustment member 95 in either one of directions around the axis of the rotary shaft 911 of the cam 91, i.e., in the direction of an arrow A or in the direction of an arrow B in FIG. 2. As the urging means 98, a spring can be used. In the case of using the spring 98, when the paper feed timing adjustment member 95 is urged in the direction of the arrow A, one end 981 of the spring 98 may be connected to an end 953 of the paper feed timing adjustment member 95, which is located toward the direction of the arrow A, while the other end (not shown) of the spring 98 may be connected to the apparatus main body. Further, when the paper feed timing adjustment member 95 is urged in the direction of the arrow B, one end (not shown) of the spring 98 may be connected to an end 954 of the paper feed timing adjustment member 95, which is located toward the direction of the arrow B, while the other end (not shown) of the spring 98 may be connected to the apparatus main body.

Next, how the paper feed section 4 with the above-described structure operates will be described with reference to FIGS. 2 and 12.

In a state where the paper 111 to be supplied is sandwiched by the timing roller 41, upon start of rotation of the stencil printing plate attachment body 31, the rotation of the cam 91 also starts in synchronization with this. Upon rotation of the cam 91, a swelled portion 913 of the cam 91 pushes the cam follower 92 in a direction away from the rotary shaft 911 of the cam 91 (i.e., in the direction of an arrow C). Actually, the end 9321 of the second arm 932 of the link mechanism 93 is fixed at a predetermined position by the paper feed timing adjustment member 95. Accordingly, when the cam follower 92 is pressed in the direction of the arrow C, the end 9311 of the first arm 931 is moved in the direction of an arrow D, i.e., the paper feed drive means 94 is operated. Upon operation of the paper feed drive means 94, the timing roller 41 is rotationally driven via the pinion gear 411. Thus, the paper 111 is supplied by the timing roller 41.

On the other hand, the paper feed timing of the timing roller 41 is adjusted by adjusting the position of the end 9321 of the second arm 932 of the link mechanism 93. This is because if the position of the end 9321 is changed, the position of the cam follower 92 on the peripheral surface 912 of the cam 91 is also changed, thus exerting an influence upon the operation timing of the paper feed drive means 94. More specifically, as shown in FIG. 12, upon movement of the position of the end 9321 in the direction of the arrow A, the position of the cam follower 92 is moved in the direction of an arrow a; thus, the timing of driving of the timing roller 41 is quickened, a paper is sent early, and the position of a printing image is moved backward accordingly. To the contrary, upon movement of the position of the end 9321 in the direction of the arrow B, the position of the cam follower 92 is moved in the direction of an arrow b; thus, the timing of driving of the timing roller 41 is delayed, a paper is sent late, and the position of a printing image is moved forward accordingly.

Furthermore, in the present invention, the position of the end 9321 is adjusted by moving the paper feed timing adjustment member 95 by the adjustment member drive means. For example, upon rotation of the adjustment member drive means in the direction of an arrow E (FIG. 2), the paper feed timing adjustment member 95 is moved in the direction of the arrow A because the gear 971 is meshing with the gear 951; accordingly, the position of the end 9321 is moved in the direction of the arrow A.

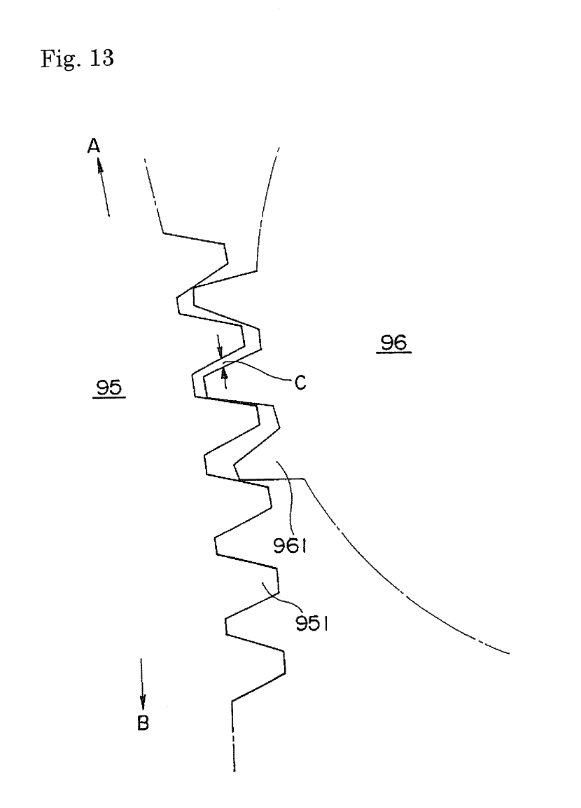

Actually, an amount of movement of the paper feed timing adjustment member 95, i.e., an amount of movement of the position of the end 9321, is set based on an amount of rotation of the adjustment member drive means. Accordingly, in the conventional technology, as described with reference to FIG. 13, an amount of movement of the position of the end 9321 becomes inaccurate due to “backlash”. However, in the present invention, the paper feed timing adjustment member 95 is constantly urged in either one of directions around the axis of the rotary shaft 911 of the cam 91 by the urging means 98; therefore, as will be described with reference to FIG. 3, a movement difference in adjusting a paper feed timing, which is caused by “backlash”, will not occur.

That is, as shown in FIG. 3, when the paper feed timing adjustment member 95 is constantly urged in the direction of the arrow A, for example, the following facts will be observed. Specifically, the gear 971 of the adjustment member drive means constantly abuts, at its surface located toward the direction of the arrow B, against the gear 951 of the paper feed timing adjustment member 95. Therefore, when the paper feed timing adjustment member 95 is moved in the direction of the arrow B, an amount of rotation of the adjustment member drive means directly becomes an amount of movement of the paper feed timing adjustment member 95, and an amount of movement of the paper feed timing adjustment member 95, i.e., an amount of movement of the position of the end 9321 becomes accurate. In addition, also when the paper feed timing adjustment member 95 is moved in the direction of the arrow A, the paper feed timing adjustment member 95 is moved in the direction of the arrow A along with a rotation of the adjustment member drive means with the gear 951 kept abutting against the gear 971 from the direction of the arrow B. In other words, the lost motion of the adjustment member drive means by a gap C will not occur. Accordingly, a movement difference in adjusting a paper feed timing, which is caused by “backlash”, will not occur.

As described above, since the stencil printing apparatus of the present invention is provided with the urging means 98, a movement difference in adjusting a paper feed timing, which is caused by “backlash”, can be prevented; accordingly, the paper feed timing of the timing roller 41 can be accurately adjusted.

Besides, in the present embodiment, since the paper feed timing adjustment member 95 is supported at the three points, the paper feed timing adjustment member 95 can be moved with stability.

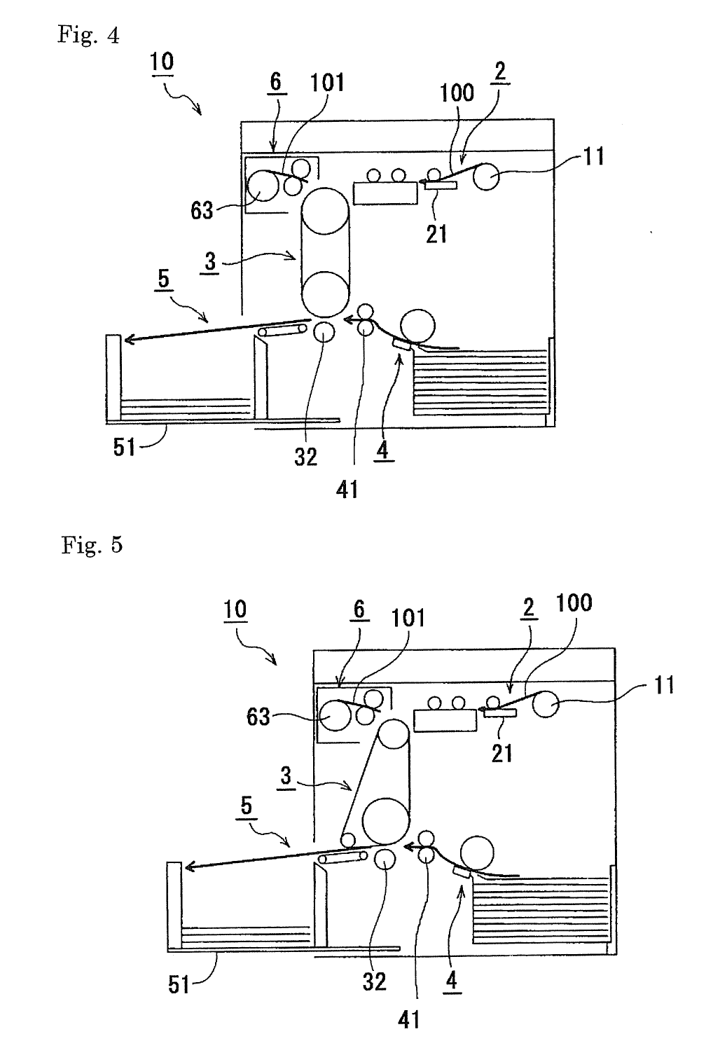

It should be noted that the paper feed section 4 with the above-described structure can be used not only when the printing section 3 is of the single-cylinder type as shown in FIG. 1, but also when the printing section 3 is of the multiple-cylinder type as shown in FIG. 4 or FIG. 5.

Moreover, in the stencil printing apparatus of the present invention, a “master roll horizontal holding mechanism” and/or a “plate discharge unit inclination adjustment mechanism”, which will be described below, are/is preferably adopted.

### (Master Roll Horizontal Holding Mechanism)

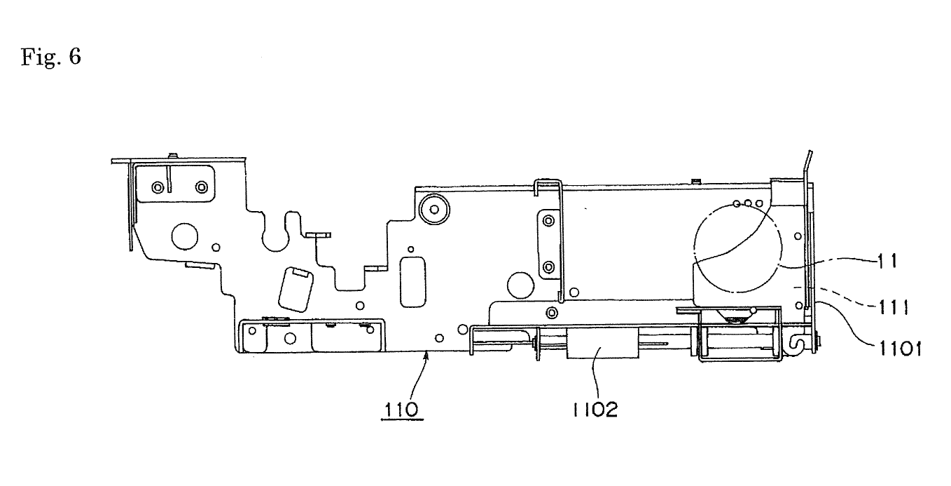

FIG. 6 is a transparent side view of a master roll holding section. The master roll 11 is located within a holding section 110 with being contained in a receiving section 111. Within the holding section 110, the receiving section 111 is urged by a spring 1102 so as to be moved toward a front wall 1101 of the holding section 110 as the master roll 11 is gradually decreased in size. Further, the receiving section 111 is supported horizontally within the holding section 110.

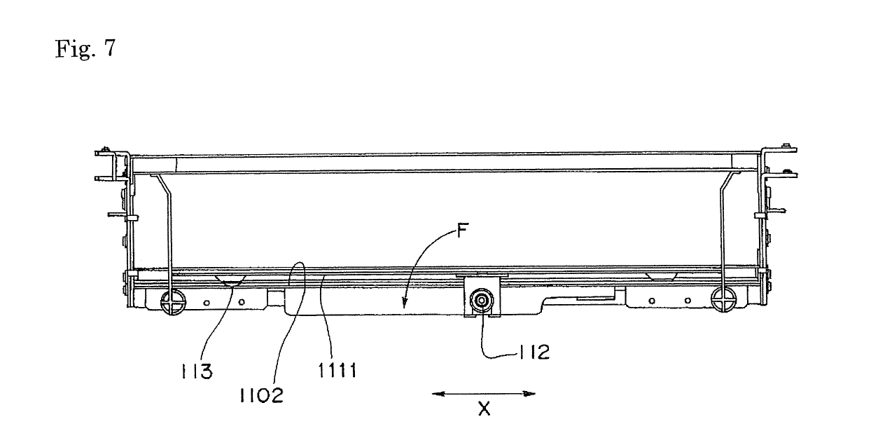

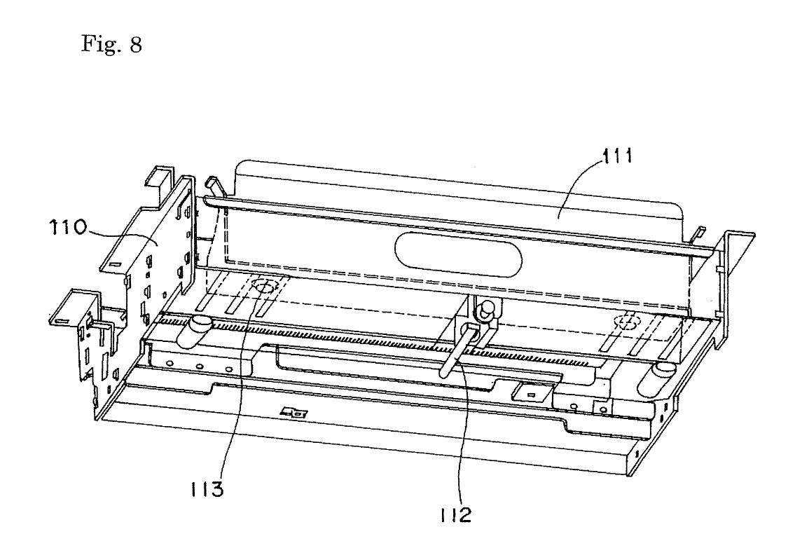

FIG. 7 is a front view of the holding section 110, viewed from the front side thereof, and FIG. 8 is a transparent perspective view of the holding section 110, viewed from below. The receiving section 111 has, at a position slightly deviated from the center of the width direction thereof (the direction of an arrow X), a rotary shaft 112, and is supported at the holding section 110 via the rotary shaft 112. Thus, due to the weight of the contained master roll 11, the receiving section 111 tends to be inclined in the direction of an arrow F by using the rotary shaft 112 as a supporting point. A lower face 1111 of the receiving section 111, at which the receiving section 111 tends to be inclined, is provided with a height adjustment member 113 that abuts against a bottom face 1102 of the holding section 110. This height adjustment member 113 is adjusted, thereby setting and maintaining the horizontal position of the receiving section 111 with respect to the bottom face 1102 of the holding section 110.

Actually, in the conventional technology, the rotary shaft 112 has been provided at the center of the width direction, and the height adjustment members 113 have been provided at both sides of the width direction; therefore, it has been necessary to accurately adjust the two height adjustment members 113 in order to maintain the horizontal position of the receiving section 111. However, in the present mechanism, since it is only necessary to adjust the single height adjustment member 113, the horizontal position of the receiving section 111 can be maintained with ease and certainty.

### (Plate Discharge Unit Inclination Adjustment Mechanism)

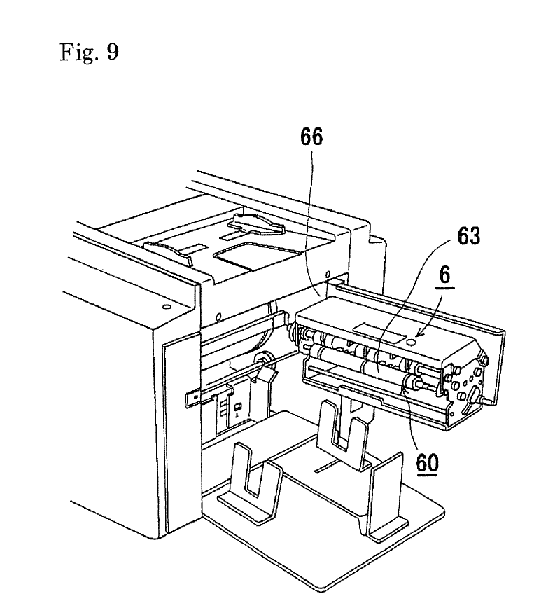

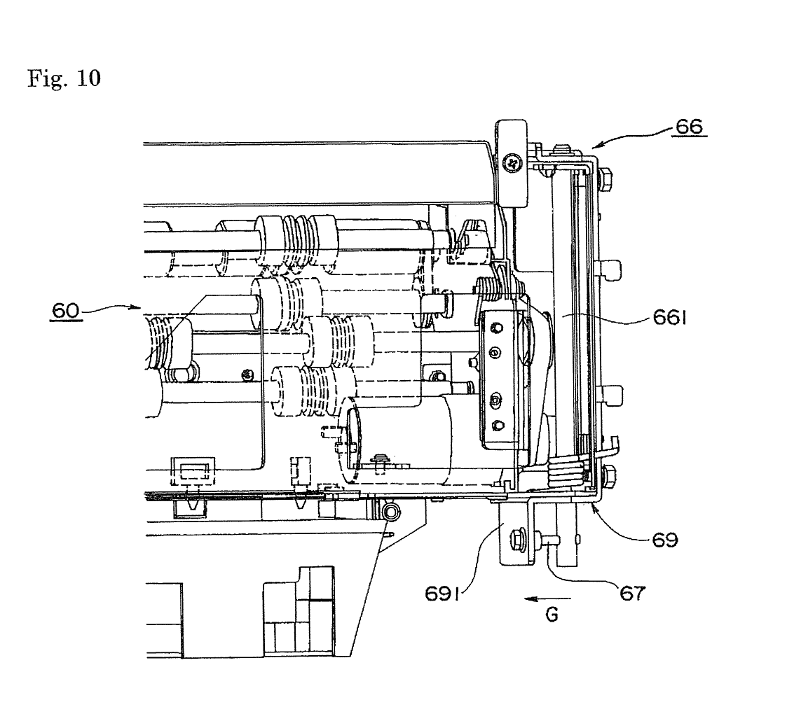

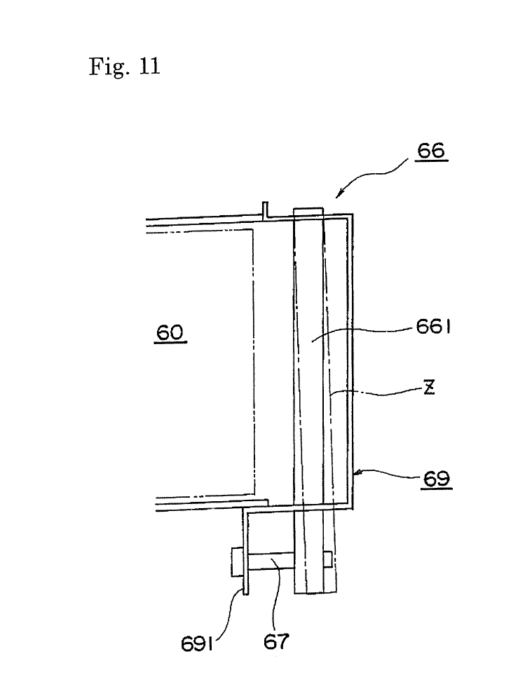

FIG. 9 shows a plate discharge unit 60 of the plate discharge section 6. The plate discharge unit 60 detachably holds the winding core 63 by which the used stencil paper 100 is wound up. The plate discharge unit 60 is supported at the apparatus main body in a cantilever manner by a hinge mechanism 66, and can be opened and closed laterally with respect to the apparatus main body via the hinge mechanism 66. FIG. 10 is a transparent side view showing the hinge mechanism 66. The hinge mechanism 66 has a hinge pin 661 for rotatably supporting the plate discharge unit 60 at a flange portion 69 of the apparatus main body. The hinge pin 661 is vertically provided. FIG. 11 is a schematic view of the hinge mechanism 66 shown in FIG. 10.

Furthermore, in the present mechanism, there is provided a pulling member 67 for pulling a lower end of the hinge pin 661 toward the plate discharge unit 60 (i.e., in the direction of an arrow G). Specifically, as the pulling member 67, it is possible to use a bolt, which is fixed at a drooping portion 691 of the flange portion 69 toward the plate discharge unit 60 and screwed into the lower end of the hinge pin 661.

Actually, in the conventional technology, the hinge pin 661 has been inclined due to the weight of the plate discharge unit 60 as indicated by the alternate long and short dashed lines Z of FIG. 11, which might interfere with the opening and closing of the plate discharge unit 60. However, in the present mechanism, the bolt 67 is tightened, thereby making it possible to pull the lower end of the hinge pin 661 toward the plate discharge unit 60, and to return the hinge pin 661 to the vertical position. Accordingly, the interference with the opening and closing of the plate discharge unit 60 due to the inclination of the hinge pin 661 can be prevented.

### INDUSTRIAL APPLICABILITY

The present invention can prevent, with a simple structure, the occurrence of a movement difference in adjusting a paper feed timing, which is caused by “backlash”, so as to enable accurate adjustment of a paper feed timing of a timing roller, and is thus industrially very useful.

1. A stencil printing apparatus comprising: a printing section having a stencil printing plate attachment body around which a stencil paper made into a plate is attached; and a paper feed section for sending a paper to the printing section,
the paper feed section comprising:
a timing roller for sending the paper to the printing section;
a cam rotated in synchronization with a rotation of the stencil printing plate attachment body;
a cam follower rolled on a sliding surface of the cam;
a link mechanism formed by connecting a first arm and a second arm to each other by using the cam follower as a joint;
paper feed drive means to which an end of the first arm is rotatably connected, and which rotationally drives the timing roller via a pinion gear in accordance with an operation of the first arm;
a paper feed timing adjustment member to which an end of the second arm is rotatably connected, and which adjusts the position of the end of the second arm around the axis of a rotary shaft of the cam; and
adjustment member drive means that meshes, via its gear, with a gear formed on a peripheral surface of the paper feed timing adjustment member, and rotates so as to cause the paper feed timing adjustment member to be moved around the axis of the rotary shaft of the cam via the meshing of the gears,
the paper feed timing adjustment member being moved around the axis of the rotary shaft of the cam by the adjustment member drive means so as to adjust the position of the end of the second arm and then the position of the cam follower on the sliding surface of the cam, thereby adjusting a driving timing of the paper feed drive means,
wherein there is provided urging means for constantly urging the paper feed timing adjustment member in either one of directions around the axis of the rotary shaft of the cam.
